(19) United States
(12) Patent Application Publication
(10) Pub. No.: US 2020/0105227 A1
(43) Pub. Date: Apr. 2, 2020

(54) METHODS AND APPARATUS FOR IMPROVING FRAME RENDERING

(71) Applicant: QUALCOMM Incorporated, San Diego, CA (US)

(72) Inventors: Bin ZHANG, Shanghai (CN); Sheng FANG, Shanghai (CN); Jun WANG, Shanghai (CN)

(21) Appl. No.: 16/289,178

(22) Filed: Feb. 28, 2019

(30) Foreign Application Priority Data
Sep. 28, 2018 (CN) PCT/CN2018/108399

(51) Int. Cl. G09G 5/18; G09G 5/12; G06T 15/00; G06T 1/20

(52) U.S. Cl. CPC G09G 5/18; G09G 5/12; G09G 2320/103; G06T 1/20; G06T 15/005

(57) ABSTRACT

The present disclosure relates to methods and apparatus of operation of a frame composer. In some aspects, the apparatus can determine whether a frame completes rendering within a first vertical synchronization (VSYNC) period, where the first VSYNC period begins at an initial VSYNC time and ends at a first VSYNC time, and the frame can complete rendering at a frame rendering completion time. The apparatus can also consume the frame at the first VSYNC time if a frame rendering completion time is before or equal to the first VSYNC time. Further, the apparatus can determine a difference between the frame rendering completion time and the first VSYNC time if the frame rendering completion time is after the first VSYNC time. The apparatus can also determine whether the difference between the frame rendering completion time and the first VSYNC time is less than or equal to a threshold.

### CROSS REFERENCE TO RELATED APPLICATION(S)

This application claims the benefit of International Application No. PCT/CN2018/108399, entitled “SMART AND DYNAMIC JANKS REDUCTION TECHNOLOGY” and filed on Sep. 28, 2018, which is expressly incorporated by reference herein in its entirety.

### TECHNICAL FIELD

The present disclosure relates generally to processing systems and, more particularly, to one or more techniques for graphics processing.

### INTRODUCTION

Computing devices often utilize a video processor or graphics processing unit (GPU) to accelerate the rendering of video or graphical data for display. Such computing devices may include, for example, computer workstations, mobile phones such as so-called smartphones, embedded systems, personal computers, tablet computers, and video game consoles. Video processors or GPUs execute a video or graphics processing pipeline that includes a plurality of processing stages that operate together to execute video or graphics processing commands and output a frame. A central processing unit (CPU) may control the operation of the video processor or GPU by issuing one or more graphics processing commands to the video processor or GPU. Modern day CPUs are typically capable of concurrently executing multiple applications, each of which may need to utilize the video processor or GPU during execution. A device that provides content for visual presentation on a display generally includes a video processor or GPU.

Typically, a video processor or GPU of a device is configured to perform every process in a video or graphics processing pipeline. However, with the advent of wireless communication and the streaming of content, e.g., game content or any other content that is rendered using a GPU, there has developed a need for improved video or graphics processing.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a frame composer. In some aspects, the apparatus can determine whether a frame completes rendering within a first vertical synchronization (VSYNC) period, where the first VSYNC period begins at an initial VSYNC time and ends at a first VSYNC time, and the frame completes rendering at a frame rendering completion time. The apparatus can also consume the frame at the first VSYNC time if the frame rendering completion time is before or equal to the first VSYNC time. Additionally, the apparatus can determine a difference between the frame rendering completion time and the first VSYNC time if the frame rendering completion time is after the first VSYNC time. The apparatus can also determine whether the difference between the frame rendering completion time and the first VSYNC time is less than or equal to a threshold. In some aspects, the apparatus can consume the frame at the frame rendering completion time if the difference between the frame rendering completion time and the first VSYNC time is less than or equal to the threshold. In other aspects, the apparatus can consume the frame at a second VSYNC time if the difference between the frame rendering completion time and the first VSYNC time is greater than the threshold, where the second VSYNC time is after the first VSYNC time.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation and coding system in accordance with one or more techniques of this disclosure.

FIG. 2 illustrates an example timing diagram in accordance with one or more techniques of this disclosure.

FIG. 3 illustrates an example timing diagram in accordance with one or more techniques of this disclosure.

FIG. 4 illustrates an example timing diagram in accordance with one or more techniques of this disclosure.

FIG. 5 illustrates an example timing diagram in accordance with one or more techniques of this disclosure.

FIG. 6 illustrates an example timing diagram in accordance with one or more techniques of this disclosure.

FIG. 7 illustrates an example timing diagram in accordance with one or more techniques of this disclosure.

FIG. 8 illustrates an example timing diagram in accordance with one or more techniques of this disclosure.

FIG. 9 illustrates an example timing diagram in accordance with one or more techniques of this disclosure.

FIG. 10 illustrates an example timing diagram in accordance with one or more techniques of this disclosure.

FIG. 11 illustrates an example timing diagram in accordance with one or more techniques of this disclosure.

FIG. 12 illustrates an example timing diagram in accordance with one or more techniques of this disclosure.

FIG. 13 illustrates an example timing diagram in accordance with one or more techniques of this disclosure.

FIG. 14 illustrates an example timing diagram in accordance with one or more techniques of this disclosure.

FIG. 15 illustrates an example flowchart of an example method in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include video processors, microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application (i.e., software) being configured to perform one or more functions. In such examples, the application may be stored on a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline across multiple devices, improving the coding of video or graphical content, and/or reducing the load of a processing unit (i.e., any processing unit configured to perform one or more techniques described herein, such as a graphics processing unit (GPU)). For example, this disclosure describes techniques for graphics processing in communication systems. Other example benefits are described throughout this disclosure.

As used herein, the term “coder” may generically refer to an encoder and/or decoder. For example, reference to a “content coder” may include reference to a content encoder and/or a content decoder. Similarly, as used herein, the term “coding” may generically refer to encoding and/or decoding. As used herein, the terms “encode” and “compress” may be used interchangeably. Similarly, the terms “decode” and “decompress” may be used interchangeably.

As used herein, instances of the term “content” may refer to the term “video,” “graphical content,” “image,” and vice versa. This is true regardless of whether the terms are being used as an adjective, noun, or other parts of speech. For example, reference to a “content coder” may include reference to a “video coder,” “graphical content coder,” or “image coder,”; and reference to a “video coder,” “graphical content coder,” or “image coder” may include reference to a “content coder.” As another example, reference to a processing unit providing content to a content coder may include reference to the processing unit providing graphical content to a video encoder. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

As used herein, instances of the term “content” may refer to graphical content or display content. In some examples, as used herein, the term “graphical content” may refer to a content generated by a processing unit configured to perform graphics processing. For example, the term “graphical content” may refer to content generated by one or more processes of a graphics processing pipeline. In some examples, as used herein, the term “graphical content” may refer to content generated by a graphics processing unit. In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling (e.g., upscaling or downscaling) on a frame. In some examples, a frame may refer to a layer. In other examples, a frame may refer to two or more layers that have already been blended together to form the frame (i.e., the frame includes two or more layers, and the frame that includes two or more layers may subsequently be blended).

As referenced herein, a first component (e.g., a processing unit) may provide content, such as graphical content, to a second component (e.g., a content coder). In some examples, the first component may provide content to the second component by storing the content in a memory accessible to the second component. In such examples, the second component may be configured to read the content stored in the memory by the first component. In other examples, the first component may provide content to the second component without any intermediary components (e.g., without memory or another component). In such examples, the first component may be described as providing content directly to the second component. For example, the first component may output the content to the second component, and the second component may be configured to store the content received from the first component in a memory, such as a buffer.

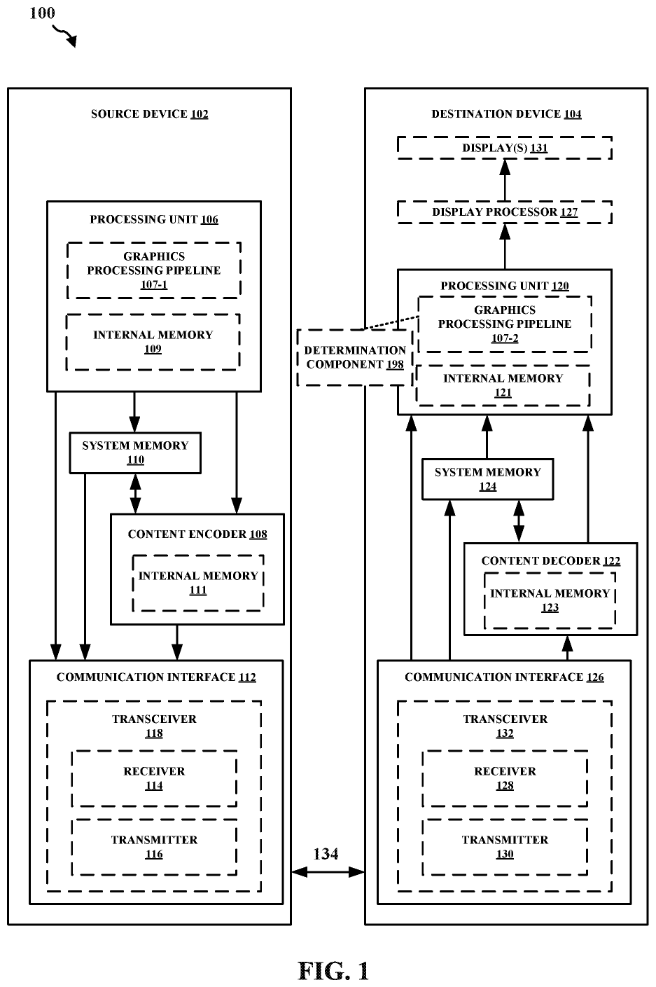

FIG. 1 is a block diagram that illustrates an example content generation and coding system 100 configured to implement one or more techniques of this disclosure. The content generation and coding system 100 includes a source device 102 and a destination device 104. In accordance with the techniques described herein, the source device 102 may be configured to encode, using the content encoder 108, graphical content generated by the processing unit 106 prior to transmission to the destination device 104. The content encoder 108 may be configured to output a bitstream having a bit rate. The processing unit 106 may be configured to control and/or influence the bit rate of the content encoder 108 based on how the processing unit 106 generates graphical content.

The source device 102 may include one or more components (or circuits) for performing various functions described herein. The destination device 104 may include one or more components (or circuits) for performing various functions described herein. In some examples, one or more components of the source device 102 may be components of a SOC. Similarly, in some examples, one or more components of the destination device 104 may be components of an SOC.

The source device 102 may include one or more components configured to perform one or more techniques of this disclosure. In the example shown, the source device 102 may include a processing unit 106, a content encoder 108, a system memory 110, and a communication interface 112. The processing unit 106 may include an internal memory 109. The processing unit 106 may be configured to perform graphics processing, such as in a graphics processing pipeline 107-1. The content encoder 108 may include an internal memory 111.

Memory external to the processing unit 106 and the content encoder 108, such as system memory 110, may be accessible to the processing unit 106 and the content encoder 108. For example, the processing unit 106 and the content encoder 108 may be configured to read from and/or write to external memory, such as the system memory 110. The processing unit 106 and the content encoder 108 may be communicatively coupled to the system memory 110 over a bus. In some examples, the processing unit 106 and the content encoder 108 may be communicatively coupled to each other over the bus or a different connection.

The content encoder 108 may be configured to receive graphical content from any source, such as the system memory 110 and/or the processing unit 106. The system memory 110 may be configured to store graphical content generated by the processing unit 106. For example, the processing unit 106 may be configured to store graphical content in the system memory 110. The content encoder 108 may be configured to receive graphical content (e.g., from the system memory 110 and/or the processing unit 106) in the form of pixel data. Otherwise described, the content encoder 108 may be configured to receive pixel data of graphical content produced by the processing unit 106. For example, the content encoder 108 may be configured to receive a value for each component (e.g., each color component) of one or more pixels of graphical content. As an example, a pixel in the red (R), green (G), blue (B) (RGB) color space may include a first value for the red component, a second value for the green component, and a third value for the blue component.

The internal memory 109, the system memory 110, and/or the internal memory 111 may include one or more volatile or non-volatile memories or storage devices. In some examples, internal memory 109, the system memory 110, and/or the internal memory 111 may include RAM, static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 109, the system memory 110, and/or the internal memory 111 may be a non-transitory storage medium according to some examples. The term “non-transitory” may indicate that the storage medium is not embodied in a carrier wave or a propagated signal. However, the term “non-transitory” should not be interpreted to mean that internal memory 109, the system memory 110, and/or the internal memory 111 is non-movable or that its contents are static. As one example, the system memory 110 may be removed from the source device 102 and moved to another device. As another example, the system memory 110 may not be removable from the source device 102.

The processing unit 106 may be a central processing unit (CPU), a graphics processing unit (GPU), a general purpose GPU (GPGPU), or any other processing unit that may be configured to perform graphics processing. In some examples, the processing unit 106 may be integrated into a motherboard of the source device 102. In some examples, the processing unit 106 may be may be present on a graphics card that is installed in a port in a motherboard of the source device 102, or may be otherwise incorporated within a peripheral device configured to interoperate with the source device 102.

The processing unit 106 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 106 may store instructions for the software in a suitable, non-transitory computer-readable storage medium (e.g., internal memory 109), and may execute the instructions in hardware using one or more processors to perform the techniques of this disclosure. Any of the foregoing (including hardware, software, a combination of hardware and software, etc.) may be considered to be one or more processors.

The content encoder 108 may be any processing unit configured to perform content encoding. In some examples, the content encoder 108 may be integrated into a motherboard of the source device 102. The content encoder 108 may include one or more processors, such as one or more video processors, microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the content encoder 108 may store instructions for the software in a suitable, non-transitory computer-readable storage medium (e.g., internal memory 111), and may execute the instructions in hardware using one or more processors to perform the techniques of this disclosure. Any of the foregoing (including hardware, software, a combination of hardware and software, etc.) may be considered to be one or more processors.

The communication interface 112 may include a receiver 114 and a transmitter 116. The receiver 114 may be configured to perform any receiving function described herein with respect to the source device 102. For example, the receiver 114 may be configured to receive information from the destination device 104, which may include a request for content. In some examples, in response to receiving the request for content, the source device 102 may be configured to perform one or more techniques described herein, such as produce or otherwise generate graphical content for delivery to the destination device 104. The transmitter 116 may be configured to perform any transmitting function described herein with respect to the source device 102. For example, the transmitter 116 may be configured to transmit encoded content to the destination device 104, such as encoded graphical content produced by the processing unit 106 and the content encoder 108 (i.e., the graphical content is produced by the processing unit 106, which the content encoder 108 receives as input to produce or otherwise generate the encoded graphical content). The receiver 114 and the transmitter 116 may be combined into a transceiver 118. In such examples, the transceiver 118 may be configured to perform any receiving function and/or transmitting function described herein with respect to the source device 102.

The destination device 104 may include one or more components configured to perform one or more techniques of this disclosure. In the example shown, the destination device 104 may include a processing unit 120, a content decoder 122, a system memory 124, a communication interface 126, and one or more displays 131. Reference to the display 131 may refer to the one or more displays 131. For example, the display 131 may include a single display or a plurality of displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon.

The processing unit 120 may include an internal memory 121. The processing unit 120 may be configured to perform video or graphics processing, such as in a graphics processing pipeline 107-2. The content decoder 122 may include an internal memory 123. In some examples, the destination device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display content that was generated using decoded content. For example, the display processor 127 may be configured to process one or more frames generated by the processing unit 120, where the one or more frames are generated by the processing unit 120 by using decoded content that was derived from encoded content received from the source device 102. In turn the display processor 127 may be configured to perform display processing on the one or more frames generated by the processing unit 120. The one or more displays 131 may be configured to display or otherwise present frames processed by the display processor 127. In some examples, the one or more display devices may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content decoder 122, such as system memory 124, may be accessible to the processing unit 120 and the content decoder 122. For example, the processing unit 120 and the content decoder 122 may be configured to read from and/or write to external memory, such as the system memory 124. The processing unit 120 and the content decoder 122 may be communicatively coupled to the system memory 124 over a bus. In some examples, the processing unit 120 and the content decoder 122 may be communicatively coupled to each other over the bus or a different connection.

The content decoder 122 may be configured to receive graphical content from any source, such as the system memory 124 and/or the communication interface 126. The system memory 124 may be configured to store received encoded graphical content, such as encoded graphical content received from the source device 102. The content decoder 122 may be configured to receive encoded graphical content (e.g., from the system memory 124 and/or the communication interface 126) in the form of encoded pixel data. The content decoder 122 may be configured to decode encoded graphical content.

The internal memory 121, the system memory 124, and/or the internal memory 123 may include one or more volatile or non-volatile memories or storage devices. In some examples, internal memory 121, the system memory 124, and/or the internal memory 123 may include RAM, SRAM, DRAM, erasable programmable ROM (EPROM), electrically erasable programmable ROM (EEPROM), Flash memory, a magnetic data media or an optical storage media, or any other type of memory.

The internal memory 121, the system memory 124, and/or the internal memory 123 may be a non-transitory storage medium according to some examples. The term “non-transitory” may indicate that the storage medium is not embodied in a carrier wave or a propagated signal. However, the term “non-transitory” should not be interpreted to mean that internal memory 121, the system memory 124, and/or the internal memory 123 is non-movable or that its contents are static. As one example, the system memory 124 may be removed from the destination device 104 and moved to another device. As another example, the system memory 124 may not be removable from the destination device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the destination device 104. In some examples, the processing unit 120 may be may be present on a graphics card that is installed in a port in a motherboard of the destination device 104, or may be otherwise incorporated within a peripheral device configured to interoperate with the destination device 104.

The processing unit 120 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium (e.g., internal memory 121), and may execute the instructions in hardware using one or more processors to perform the techniques of this disclosure. Any of the foregoing (including hardware, software, a combination of hardware and software, etc.) may be considered to be one or more processors.

The content decoder 122 may be any processing unit configured to perform content decoding. In some examples, the content decoder 122 may be integrated into a motherboard of the destination device 104. The content decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content decoder 122 may store instructions for the software in a suitable, non-transitory computer-readable storage medium (e.g., internal memory 123), and may execute the instructions in hardware using one or more processors to perform the techniques of this disclosure. Any of the foregoing (including hardware, software, a combination of hardware and software, etc.) may be considered to be one or more processors.

The communication interface 126 may include a receiver 128 and a transmitter 130. The receiver 128 may be configured to perform any receiving function described herein with respect to the destination device 104. For example, the receiver 128 may be configured to receive information from the source device 102, which may include encoded content, such as encoded graphical content produced or otherwise generated by the processing unit 106 and the content encoder 108 of the source device 102 (i.e., the graphical content is produced by the processing unit 106, which the content encoder 108 receives as input to produce or otherwise generate the encoded graphical content). As another example, the receiver 114 may be configured to receive position information from the destination device 104, which may be encoded or unencoded (i.e., not encoded). Additionally, the receiver 128 may be configured to receive position information from the source device 102. In some examples, the destination device 104 may be configured to decode encoded graphical content received from the source device 102 in accordance with the techniques described herein. For example, the content decoder 122 may be configured to decode encoded graphical content to produce or otherwise generate decoded graphical content. The processing unit 120 may be configured to use the decoded graphical content to produce or otherwise generate one or more frames for presentment on the one or more displays 131. The transmitter 130 may be configured to perform any transmitting function described herein with respect to the destination device 104. For example, the transmitter 130 may be configured to transmit information to the source device 102, which may include a request for content. The receiver 128 and the transmitter 130 may be combined into a transceiver 132. In such examples, the transceiver 132 may be configured to perform any receiving function and/or transmitting function described herein with respect to the destination device 104.

The content encoder 108 and the content decoder 122 of content generation and coding system 100 represent examples of computing components (e.g., processing units) that may be configured to perform one or more techniques for encoding content and decoding content in accordance with various examples described in this disclosure, respectively. In some examples, the content encoder 108 and the content decoder 122 may be configured to operate in accordance with a content coding standard, such as a video coding standard, a display stream compression standard, or an image compression standard.

As shown in FIG. 1, the source device 102 may be configured to generate encoded content. Accordingly, the source device 102 may be referred to as a content encoding device or a content encoding apparatus. The destination device 104 may be configured to decode the encoded content generated by source device 102. Accordingly, the destination device 104 may be referred to as a content decoding device or a content decoding apparatus. In some examples, the source device 102 and the destination device 104 may be separate devices, as shown. In other examples, source device 102 and destination device 104 may be on or part of the same computing device. In some instances, a graphics processing pipeline may be distributed between the two devices. For example, a single graphics processing pipeline may include a plurality of video or graphics processes. The graphics processing pipeline 107-1 may include one or more video or graphics processes of the plurality of video or graphics processes. Similarly, graphics processing pipeline 107-2 may include one or more video or graphics processes of the plurality of video or graphics processes. In this regard, the graphics processing pipeline 107-1 concatenated or otherwise followed by the graphics processing pipeline 107-2 may result in a full video or graphics processing pipeline. Otherwise described, the graphics processing pipeline 107-1 may be a partial video or graphics processing pipeline and the graphics processing pipeline 107-2 may be a partial video or graphics processing pipeline that, when combined, result in an improved video or graphics processing pipeline.

Referring again to FIG. 1, in certain aspects, the graphics processing pipeline 107-2 may include a determination component 198 configured to determine whether a frame completes rendering within a first VSYNC period, where the first VSYNC period begins at an initial VSYNC time and ends at a first VSYNC time, and the frame completes rendering at a frame rendering completion time. The determination component 198 can also be configured to consume the frame at the first VSYNC time if the frame rendering completion time is before or equal to the first VSYNC time. The determination component 198 can also be configured to determine a difference between the frame rendering completion time and the first VSYNC time if the frame rendering completion time is after the first VSYNC time. Additionally, the determination component 198 can be configured to determine whether the difference between the frame rendering completion time and the first VSYNC time is less than or equal to a threshold. In some aspects, the determination component 198 can be configured to consume the frame at the frame rendering completion time if the difference between the frame rendering completion time and the first VSYNC time is less than or equal to the threshold. In other aspects, the determination component 198 can be configured to consume the frame at a second VSYNC time if the difference between the frame rendering completion time and the first VSYNC time is greater than the threshold, where the second VSYNC time is after the first VSYNC time. By distributing the graphics processing pipeline between the source device 102 and the destination device 104, the destination device may be able to, in some examples, present graphical content that it otherwise would not be able to render or present. Other example benefits are described throughout this disclosure.

As described herein, a device, such as the source device 102 and/or the destination device 104, may refer to any device, apparatus, or system configured to perform one or more techniques described herein. For example, a device may be a server, a base station, user equipment, a client device, a station, an access point, a computer (e.g., a personal computer, a desktop computer, a laptop computer, a tablet computer, a computer workstation, or a mainframe computer), an end product, an apparatus, a phone, a smart phone, a server, a video game platform or console, a handheld device (e.g., a portable video game device or a personal digital assistant (PDA)), a wearable computing device (e.g., a smart watch, an augmented reality device, or a virtual reality device), a non-wearable device, an augmented reality device, a virtual reality device, a display (e.g., display device), a television, a television set-top box, an intermediate network device, a digital media player, a video streaming device, a content streaming device, an in-car computer, any mobile device, any device configured to generate graphical content, or any device configured to perform one or more techniques described herein.

Source device 102 may be configured to communicate with the destination device 104. For example, destination device 104 may be configured to receive encoded content from the source device 102. In some example, the communication coupling between the source device 102 and the destination device 104 is shown as link 134. Link 134 may comprise any type of medium or device capable of moving the encoded content from source device 102 to the destination device 104.

In the example of FIG. 1, link 134 may comprise a communication medium to enable the source device 102 to transmit encoded content to destination device 104 in real-time. The encoded content may be modulated according to a communication standard, such as a wireless communication protocol, and transmitted to destination device 104. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 102 to the destination device 104. In other examples, link 134 may be a point-to-point connection between source device 102 and destination device 104, such as a wired or wireless display link connection (e.g., a high definition multimedia interface (HDMI) link, a DisplayPort link, a Mobile Industry Processor Interface (MIPI) display serial interface (DSI) link, or another link over which encoded content may traverse from the source device 102 to the destination device 104.

In another example, the link 134 may include a storage medium configured to store encoded content generated by the source device 102. In this example, the destination device 104 may be configured to access the storage medium. The storage medium may include a variety of locally-accessed data storage media such as Blu-ray discs, DVDs, CD-ROMs, flash memory, or other suitable digital storage media for storing encoded content.

In another example, the link 134 may include a server or another intermediate storage device configured to store encoded content generated by the source device 102. In this example, the destination device 104 may be configured to access encoded content stored at the server or other intermediate storage device. The server may be a type of server capable of storing encoded content and transmitting the encoded content to the destination device 104.

Devices described herein may be configured to communicate with each other, such as the source device 102 and the destination device 104. Communication may include the transmission and/or reception of information. The information may be carried in one or more messages. As an example, a first device in communication with a second device may be described as being communicatively coupled to or otherwise with the second device. For example, a client device and a server may be communicatively coupled. As another example, a server may be communicatively coupled to a plurality of client devices. As another example, any device described herein configured to perform one or more techniques of this disclosure may be communicatively coupled to one or more other devices configured to perform one or more techniques of this disclosure. In some examples, when communicatively coupled, two devices may be actively transmitting or receiving information, or may be configured to transmit or receive information. If not communicatively coupled, any two devices may be configured to communicatively couple with each other, such as in accordance with one or more communication protocols compliant with one or more communication standards. Reference to “any two devices” does not mean that only two devices may be configured to communicatively couple with each other; rather, any two devices is inclusive of more than two devices. For example, a first device may communicatively couple with a second device and the first device may communicatively couple with a third device. In such an example, the first device may be a server.

With reference to FIG. 1, the source device 102 may be described as being communicatively coupled to the destination device 104. In some examples, the term “communicatively coupled” may refer to a communication connection, which may be direct or indirect. The link 134 may, in some examples, represent a communication coupling between the source device 102 and the destination device 104. A communication connection may be wired and/or wireless. A wired connection may refer to a conductive path, a trace, or a physical medium (excluding wireless physical mediums) over which information may travel. A conductive path may refer to any conductor of any length, such as a conductive pad, a conductive via, a conductive plane, a conductive trace, or any conductive medium. A direct communication connection may refer to a connection in which no intermediary component resides between the two communicatively coupled components. An indirect communication connection may refer to a connection in which at least one intermediary component resides between the two communicatively coupled components. Two devices that are communicatively coupled may communicate with each other over one or more different types of networks (e.g., a wireless network and/or a wired network) in accordance with one or more communication protocols. In some examples, two devices that are communicatively coupled may associate with one another through an association process. In other examples, two devices that are communicatively coupled may communicate with each other without engaging in an association process. For example, a device, such as the source device 102, may be configured to unicast, broadcast, multicast, or otherwise transmit information (e.g., encoded content) to one or more other devices (e.g., one or more destination devices, which includes the destination device 104). The destination device 104 in this example may be described as being communicatively coupled with each of the one or more other devices. In some examples, a communication connection may enable the transmission and/or receipt of information. For example, a first device communicatively coupled to a second device may be configured to transmit information to the second device and/or receive information from the second device in accordance with the techniques of this disclosure. Similarly, the second device in this example may be configured to transmit information to the first device and/or receive information from the first device in accordance with the techniques of this disclosure. In some examples, the term “communicatively coupled” may refer to a temporary, intermittent, or permanent communication connection.

Any device described herein, such as the source device 102 and the destination device 104, may be configured to operate in accordance with one or more communication protocols. For example, the source device 102 may be configured to communicate with (e.g., receive information from and/or transmit information to) the destination device 104 using one or more communication protocols. In such an example, the source device 102 may be described as communicating with the destination device 104 over a connection. The connection may be compliant or otherwise be in accordance with a communication protocol. Similarly, the destination device 104 may be configured to communicate with (e.g., receive information from and/or transmit information to) the source device 102 using one or more communication protocols. In such an example, the destination device 104 may be described as communicating with the source device 102 over a connection. The connection may be compliant or otherwise be in accordance with a communication protocol.

As used herein, the term “communication protocol” may refer to any communication protocol, such as a communication protocol compliant with a communication standard or the like. As used herein, the term “communication standard” may include any communication standard, such as a wireless communication standard and/or a wired communication standard. A wireless communication standard may correspond to a wireless network. As an example, a communication standard may include any wireless communication standard corresponding to a wireless personal area network (WPAN) standard, such as Bluetooth (e.g., IEEE 802.15), Bluetooth low energy (BLE) (e.g., IEEE 802.15.4). As another example, a communication standard may include any wireless communication standard corresponding to a wireless local area network (WLAN) standard, such as WI-FI (e.g., any 802.11 standard, such as 802.11a, 802.11b, 802.11c, 802.11n, or 802.11ax). As another example, a communication standard may include any wireless communication standard corresponding to a wireless wide area network (WWAN) standard, such as 3G, 4G, 4G LTE, or 5G.

With reference to FIG. 1, the content encoder 108 may be configured to encode video or graphical content. In some examples, the content encoder 108 may be configured to encode video or graphical content as one or more video frames. When the content encoder 108 encodes content, the content encoder 108 may generate a bitstream. The bitstream may have a bit rate, such as bits/time unit, where time unit is any time unit, such as second or minute. The bitstream may include a sequence of bits that form a coded representation of the video or graphical content and associated data. To generate the bitstream, the content encoder 108 may be configured to perform encoding operations on pixel data, such as pixel data corresponding to a shaded texture atlas. For example, when the content encoder 108 performs encoding operations on image data (e.g., one or more blocks of a shaded texture atlas) provided as input to the content encoder 108, the content encoder 108 may generate a series of coded images and associated data. The associated data may include a set of coding parameters such as a quantization parameter (QP).

The mobile gaming market is one of the most important markets in the mobile world. In this market, users care greatly about the game performance. A variety of factors can be performance indicators for the mobile gaming market. For instance, frames per second (FPS) and janks, i.e., delays or pauses in frame rendering or composition, are important key performance indicators (KPI) in this market. In some aspects, a jank can be a perceptible pause in the rendering of a software application's user interface. Both FPS and janks are KPIs in game performance and/or device display capability. In mobile gaming applications, janks can be the result of a number of factors, such as slow operations or poor interface design. In some instances, a jank can also correspond to a change in the refresh rate of the display at the device. Janks are important to mobile gaming because if the display fresh latency is not stable, this can impact the user experience. Accordingly, some aspects of the mobile gaming industry are focused on reducing janks and increasing FPS.

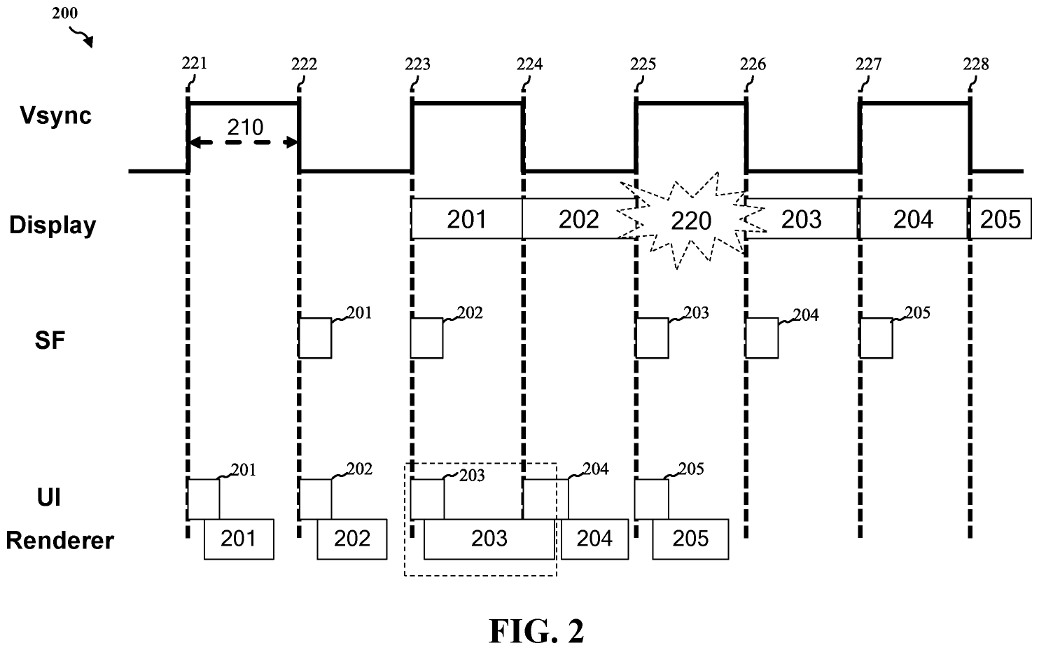

FIG. 2 illustrates an example timing diagram 200 according to the present disclosure. As shown in FIG. 2, timing diagram 200 includes first frame 201, second frame 202, third frame 203, fourth frame 204, fifth frame 205, VSYNC time period 210, jank 220, first VSYNC time 221, second VSYNC time 222, third VSYNC time 223, fourth VSYNC time 224, fifth VSYNC time 225, sixth VSYNC time 226, seventh VSYNC time 227, and eighth VSYNC time 228. FIG. 2 also displays a renderer, a user interface (UI), a surface flinger (SF) mechanism, a display or display engine, and a VSYNC timing mechanism. The display or display engine can also be referred to as a display buffer. FIG. 2 displays a mobile gaming application that experiences a jank 220 during the application run time. VSYNC time period 210 can correspond to the same amount of time between successive VSYNC times. In some aspects, VSYNC time period 210 can be 16.67 ms. SF mechanism in FIG. 2 can be different or distinct from the smart surface flinger (SSF) mechanisms according to the present disclosure and described herein.

As shown in FIG. 2, the jank 220 is experienced at the display between the second frame 202 and the third frame 203. More specifically, jank 220 is the result of renderer taking too long to render the third frame 203. As shown in FIG. 2, the renderer finishes rendering the third frame 203 after the scheduled VSYNC time, e.g., the fourth VSYNC time 224. The delayed rendering of the third frame 203 results in the jank 220 and a corresponding delay in frame displays. As such, the frame 203 is consumed or sent to the display after its scheduled VSYNC time, e.g., the fifth VSYNC time 225, and is instead consumed at the sixth VSYNC time 226. Accordingly, the frame 203 is sent to the display one VSYNC period later than scheduled, e.g., between the sixth VSYNC time 226 and the seventh VSYNC time 227. In frame composer examples such as FIG. 2, a frame can only be consumed or sent to the display at a VSYNC time, so if a frame rendering extends past a designated VSYNC time, then a resulting jank can occur.

As indicated above, if frame takes too long to be rendered and is not ready for transmission to a display at a scheduled VSYNC time, this can result in a delayed frame display time and a corresponding jank. Essentially, janks can be the result of a delayed frame rendering. In some aspects, a frame buffer or buffer queue can queue frames waiting to be sent to the display. If a frame takes too long to be rendered, e.g., frame 203, then the frame is not consumed or sent to the buffer queue by the scheduled VSYNC time. In some aspects, the SF can consume the frame or help send the frame to the buffer queue or display. If the renderer takes too long to render a frame, then the SF mechanism may be delayed in consuming the frame, so the frame will be delayed in being transmitted to the display. As such, a delay in rendering can cause a resulting delay in frame consumption or display transmission. In some aspects, if a frame has not finished rendering by a scheduled VSYNC time, then the frame will not be transmitted to a buffer queue. In these aspects, if there are no frames in the buffer queue, then the SF will not be triggered to consume the frame. As the frame is not consumed, this can result in a jank.

The present disclosure can provide a number of advantages and solutions to the mobile gaming industry, such as providing improved and dynamic janks reduction technology. In some aspects, the present disclosure can monitor the frame or application rendering status and/or the compositor status. In further aspects, the present disclosure can detect a potentially harmful scenario dynamically in advance, e.g., a frame taking too long to be rendered. The present disclosure can also maintain any situations of the render/composition pipeline that may help to reduce janks. In other aspects, the present disclosure can provide a SSF mechanism that can reduce janks without any corresponding reduction in power.

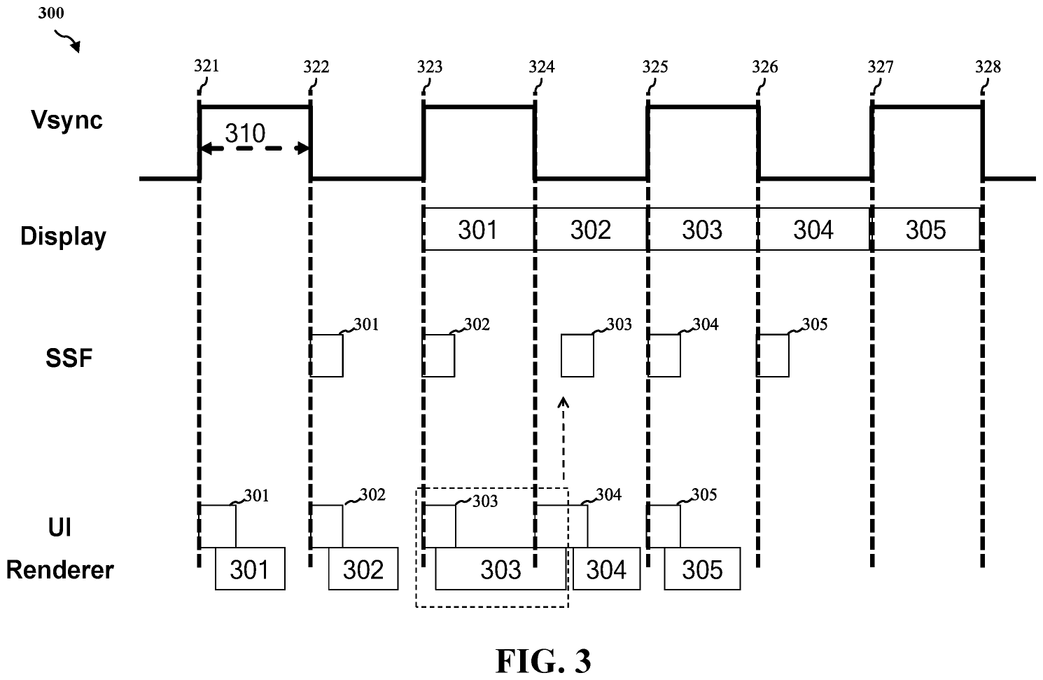

FIG. 3 illustrates another example timing diagram 300 according to the present disclosure. As shown in FIG. 3, timing diagram 300 includes first frame 301, second frame 302, third frame 303, fourth frame 304, fifth frame 305, VSYNC time period 310, first VSYNC time 321, second VSYNC time 322, third VSYNC time 323, fourth VSYNC time 324, fifth VSYNC time 325, sixth VSYNC time 326, seventh VSYNC time 327, and eighth VSYNC time 328. FIG. 3 also displays a renderer, a UI, a SSF mechanism, a display or display engine, and a VSYNC timing mechanism. In some aspects, VSYNC time period 310 can be 16.67 ms. FIG. 3 displays a mobile gaming application that experiences a delayed frame rendering, e.g., third frame 303, but does not experience a corresponding jank during the application run time based on this delayed rendering.

As shown in FIG. 3, the renderer finishes rendering the third frame 303 after the scheduled VSYNC time, e.g., the fourth VSYNC time 324. However, the delayed rendering of the third frame 303 does not result in a jank or a corresponding delay in frame displays. This is because the SSF mechanism of the present disclosure can consume or send a frame to the display between designated VSYNC times. As shown in FIG. 3, SSF mechanism consumes the third frame 303 once it is finished rendering, e.g., between the fourth VSYNC time 324 and the fifth VSYNC time 325. Thus, the frame 303 is consumed or sent to the display by its scheduled VSYNC time, e.g., the fifth VSYNC time 225. As such, the frame 303 is displayed at its schedule VSYNC period, e.g., between the fifth VSYNC time 325 and the sixth VSYNC time 326. As shown in FIG. 3, in frame composer examples of the present disclosure, a frame can only be consumed or sent to the display at any time, e.g., between VSYNC times. Therefore, if a frame rendering extends past a designated VSYNC time, then the present disclosure may not experience a corresponding jank.

As shown in FIG. 3, frame composers herein may determine whether a frame completes rendering within a first VSYNC period. For example, regarding frame 303, the first VSYNC period can begin at third VSYNC time 323 and end at fourth VSYNC time 324. The frame 303 can complete rendering at a frame rendering completion time. In some aspects, frame 303 can be consumed at the fourth VSYNC time 324 if the frame rendering completion time is before or equal to the fourth VSYNC time 324. The frame composer can determine a difference between the frame rendering completion time and the fourth VSYNC time 324 if the frame rendering completion time is after the fourth VSYNC time 324. Additionally, the frame composer can determine whether the difference between the frame rendering completion time and the fourth VSYNC time 324 is less than or equal to a threshold. The frame composer can consume the frame 303 at the frame rendering completion time if the difference between the frame rendering completion time and the fourth VSYNC time 324 is less than or equal to the threshold. As shown in FIG. 3, the frame 303 is consumed at the frame rendering completion time. For instance, as displayed in FIG. 3, the SSF mechanism consumes the frame 303 once the frame 303 completes rendering, e.g., between VSYNC time 324 and VSYNC time 325. Further, the frame composer can consume the frame 303 at the fifth VSYNC time 325 if the difference between the frame rendering completion time and the fourth VSYNC time 324 is greater than the threshold. Accordingly, if the frame 303 completes rendering just before fifth VSYNC time 325, the frame composer can determine that the difference between the frame rendering completion time and the fourth VSYNC time 324 is greater than the threshold, so the frame 303 can be consumed at the fifth VSYNC time 325.

In some aspects, e.g., in game modes mentioned herein, the frame 303 can be consumed at the frame rendering completion time even if the frame rendering completion time is before or equal to the fourth VSYNC time 324. In these aspects, the frame composer may not wait for a designated VSYNC time to consume the frame or send the frame to the display. In some instances, the frame composer can send the frame 303 to a buffer queue when the frame completes rendering. Also, the frame composer can increase a buffer queue counter of the buffer queue when the frame 303 completes rendering. Further, regarding frame 303, a processing speed of the frame composer can be based on the difference between the frame rendering completion time and the fourth VSYNC time 324. In some aspects, increasing the processing speed of the frame composer can increase the time length required to render a frame or the time length required to consume a or transmit a frame to the display.

As mentioned herein, the present disclosure can include a SSF mechanism that can help to reduce janks. For example, the SSF mechanisms herein can help to reduce janks when frame renderings or transmissions are delayed. In some aspects, when a frame is ready to be consumed or transmitted to the display, the SSF mechanism can allow the frame composer to consume the frame once the rendering is complete, which can help to reduce any potential janks based on a delayed rendering. For instance, if the frame has not finished rendering by a designated VSYNC time, then the SSF mechanism can wait on a frame to finish rendering before allowing the frame composer to consume the frame. In these instances, the SSF can be triggered to consume the frame or transmit a frame to the display engine or buffer queue. In some aspects, when the buffer queue is ready for a frame, the SSF mechanism can be triggered to send a frame and reduce the jank impact of the delayed frame rendering. In further aspects, the SSF mechanism can allow the frame composer to consume the frame at any time, e.g., before, equal to, or after a designated VSYNC time, in order to reduce janks.

As mentioned here, aspects of the present disclosure can include a renderer, e.g., for rendering frames and/or transmitting frames to a display. For instance, the renderer can render each frame once it is ready and then send it to the buffer queue or the display engine. Once a frame is send to the buffer queue, a buffer queue counter can then be increased by one frame (or more than one frame depending on how many frames are sent to the buffer queue). In some aspects, once a frame is sent to the buffer queue, the SSF mechanism can be signaled to consume the frame or transmit the frame to the display. In one aspect, the SSF can transmit a pipeline of each frame layer to the display engine and allow the display engine to begin composition of the frame. In another aspect, a game processor can transmit the frame to the display engine and a subsignal can instruct the display engine to consume the frame. As mentioned herein, the SSF mechanism can enable a frame to be consumed or transmitted to the display between designated VSYNC times. Further, the SSF mechanism can detect if there is an available frame in the buffer queue, e.g., for consumption or transmission to the display.

As mentioned above, a frame, e.g., frame 303, may take longer to render than anticipated, which can result in the frame not completing rendering by a designated VSYNC time, e.g., fourth VSYNC time 324. As further mentioned herein, the SSF mechanism can allow the frame to be consumed by the frame composer after a designated VSYNC time. In some aspects, the SSF mechanism can consume the frame, such that the display will not experience a jank as a result of the delayed frame transmission. So the present disclosure can allow a frame composer to consume a frame once it has completed rendering and may not need to wait for a designated VSYNC time or signal. In other aspects, there can be a delay latency threshold, which can determine the latency between the frame rendering completion time and the designated VSYNC time. If the latency is within the threshold, the SSF mechanism can allow the frame composer to consume the frame immediately once the frame completes rendering. If the latency is beyond threshold, then the frame composer may wait for a subsequent VSYNC time to consume the frame.

Some aspects of the present disclosure can also include multiple modes. For instance, the present disclosure can include a normal mode, which can include by-passing the VSYNC signal in a surface flinger or SSF mechanism for frames that match certain conditions. In normal mode, the present disclosure can use VSYNC signals and the SSF mechanism can bypass the VSYNC signal if the frame matches certain conditions, e.g., if the frame is sent after a designated VSYNC time. The present disclosure can also include a game mode, which can cause a bypass in the VSYNC signal timing, such that the SSF mechanism can consumes the frames without determining the VSYNC time. Accordingly, the timing of frame consumption may not be dependent on a designated VSYNC time. In some aspects, the present disclosure can utilize game mode to reduce latency while playing a game. Also, a rendered frame can trigger the SSF mechanism regardless of the time it is sent from the renderer or completes rendering. As mentioned herein, the present disclosure can reduce the frame response latency when in game mode. In some aspects, when a frame has completed rendering, it can trigger the SSF mechanism for immediate consumption. Use of the game mode according to the present disclosure can also include a janks detection algorithm. Additionally, the buffer queue status or frames in the buffer queue can be monitor dynamically in game mode.

As mentioned above, game mode can include by-passing the VSYNC signal in a surface flinger for frames that match conditions. Also, game modes according to the present disclosure can include a CPU hint and/or GPU hint strategy for frames that match certain conditions. Because the CPU or GPU can be boosted or increased when utilizing CPU hint or GPU hint, the frame can be consumed or transmitted to the display at any time. CPU hint or GPU hint can also monitor the buffer queue status dynamically. In some aspects, the CPU can be boosted with differing intensities. For instance, the CPU can be boosted at a number of different percentages, e.g., 10% in some aspects and 30% in other aspects. For example, if a frame is being rendered 2 ms after a VSYNC time, the present disclosure may require a lower CPU boost, e.g., a 10% boost, compared to if a frame is being rendered 6 ms after the VSYNC time, e.g., a 30% boost. Additionally, CPU boost can help to consume or transmit a frame prior to a subsequent VSYNC time if the frame was rendered after the prior VSYNC time.

In yet other aspects, the threshold in game mode used to ensure that the VSYNC is bypassed can also depend on how much the CPU is adjusted. As such, the threshold that triggers the SSF mechanism can vary. In some instances, the threshold can depend on CPU balancing. So the present disclosure can adjust the threshold depending on the CPU workload or boost. For example, in normal mode, the SSF mechanism can be activated or triggered if certain conditions match, e.g., if a frame is rendered after the designated VSYNC time. In game mode, the SSF mechanism can be triggered each instance a frame completes rendering, e.g., the SSF mechanism can consume or transmit a frame at a frame rendering completion time. As such, a game mode can bypass the VSYNC timing, so the present disclosure may not need to wait for a designated VSYNC time. In some aspects, to enable game mode, the present disclosure can verify if a platform supports game mode or can enable SSF through an application. The return value can be that the device supports a SSF mechanism. Some advantages of this module can be that SSF may only be supported for games that can be verified. In some aspects, this can limit the risk caused by the SSF.

Game modes according to the present disclosure can also include a number of different functions. For instance, as mentioned supra, game modes herein can include a janks detection algorithm. Games modes herein can also include a mAheadNum variable, which can indicate how many VSYNC cycles are between a buffer queue or queueBuffer function and the expected rendering completion time of a current frame. The mAheadNum variable can also be used to indicate the trend of a frame fresh latency from an application side. Also, the mAheadNum variable or other variables herein may be used to indicate the statistics of a variety of different game variables, such as any of the game variables mentioned herein. Further, a diffDispToQB variable can include the duration between the current queueBuffer call and the rendering completion timestamp of a previous frame. Also, a diffDispFrame variable can include the duration between the rendering completion timestamp of a previous frame and a present frame. Another variable according to the present disclosure can be the mLastDiffDispToQB function, which can include the previous diffDispToQB value. In addition, the present disclosure can include a mLastDiffDispFrame variable, which can include the previous diffDispFrame value.

Other aspects of the present disclosure can include VSYNC timing offsets, such as a dynamic on-off VSYNC offset function. Also, the present disclosure can maintain or enable certain signals, e.g., a HWVsync signal, in during the frame rendering or composition process, e.g., with a SF or SSF mechanism. In some aspects, the VSYNC offset function can be controlled dynamically with an on-off switch. For instance, in normal mode, the on-off switch can be controlled by a function, e.g., a persist.vendor.qti.ssf.normal function, that can enable or disable the on-off switch. In game mode, the on-off switch can also be controlled by a function, e.g., a persist.vendor.qti.ssfgame function or a persist.vendor.qti.ssfgame.enable function, which can enable or disable the on-off switch through an application or other means.

In order to enable game mode, the present disclosure can determine if the platform supports the SSF game mode and/or enable the SSF mechanism through an application or other means. In some aspects, the present disclosure can determine if the gaming application or device supports the SSF mechanism. By doing so, the present disclosure may save power, such as by only running the SSF mechanism for gaming applications or devices that indicate they support the SSF mechanism. Additionally, this can limit any power or other risk caused by the SSF mechanism and/or overuse of this feature.

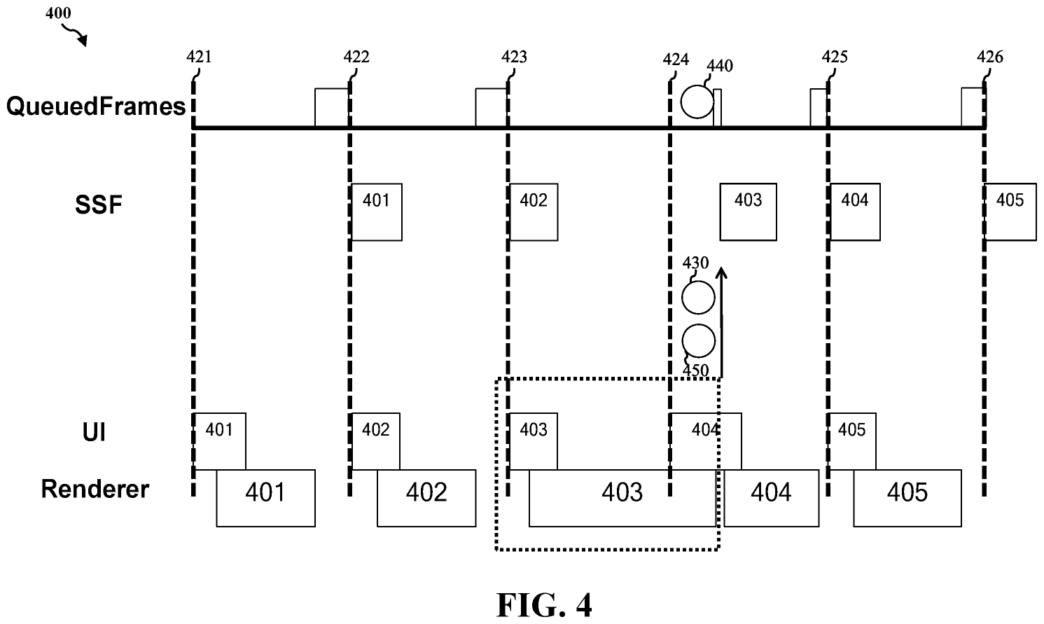

FIG. 4 illustrates another example timing diagram 400 according to the present disclosure. As shown in FIG. 4, timing diagram 400 includes first frame 401, second frame 402, third frame 403, fourth frame 404, fifth frame 405, first VSYNC time 421, second VSYNC time 422, third VSYNC time 423, fourth VSYNC time 424, fifth VSYNC time 425, and sixth VSYNC time 426. FIG. 4 also displays a renderer, a UI, a SSF mechanism, and frames stored in the buffer queue (shown in FIG. 4 as queuedframes). FIG. 4 is similar to FIG. 3, but shows the frames in the buffer queue rather than the display and VSYNC timing. In some aspects, the time period between adjacent VSYNC times, e.g., between first VSYNC time 421 and second VSYNC time 422, can be 16.67 ms. FIG. 4 displays a mobile gaming application that experiences a delayed frame rendering past a subsequent VSYNC time, e.g., third frame 403 is rendered past fourth VSYNC time 424, but does not experience a corresponding jank.

FIG. 4 displays an example of a frame composer according to the present disclosure in the normal mode. For example, frame 403 is rendered past fourth VSYNC time 424, so the frame 403 is consumed by the SSF mechanism immediately once the rendering is complete. However, the remaining frames, e.g., frames 401, 402, 404, and 405, are consumed as a subsequent VSYNC time, e.g., VSYNC time 422, 423, 425, and 426, respectively. For instance, as frames 401, 402, 404, and 405 are not rendered past the subsequent VSYNC time, then the frames are consumed at the subsequent VSYNC time. Frame 403 is consumed by SSF mechanism immediately upon finishing rendering, as only frame 403 completes rendering past the subsequent VSYNC time, e.g., VSYNC time 424.

FIG. 4 also displays that timing diagram 400 includes three points, e.g., point 430, point 440, and point 450. Point 430 can be the point at which the queueBuffer function misses the VSYNC signal and is the expected time that frame 403 should be sent to the buffer queue. For instance, as frame 403 completes rendering after VSYNC time 424, then frame 403 is not sent to the buffer queue at point 430. Rather, frame 403 is briefly sent to the buffer queue once it completes rendering after point 430. As shown in FIG. 4, frames 401, 402, 403, 404, 405 are sent to the buffer queue once they are finished rendering. Also, at point 430 the latency between VSYNC time 424 and the point at which frame 403 completes rendering can be less than a threshold. For example, the latency can be 4 ms. As the latency is less than a threshold, the SSF mechanism consumes the frame 403 immediately upon rendering and sends frame 403 to the buffer queue. At point 440, the value of mQueuedFrames can be set to a value of one, which means that there is only one available frame in the buffer queue. Point 450 is the point at which SSF mechanism missed being triggered when the previous VSYNC signal was transmitted, e.g., at VSYNC time 424, as frame 403 had not yet completed rendering.

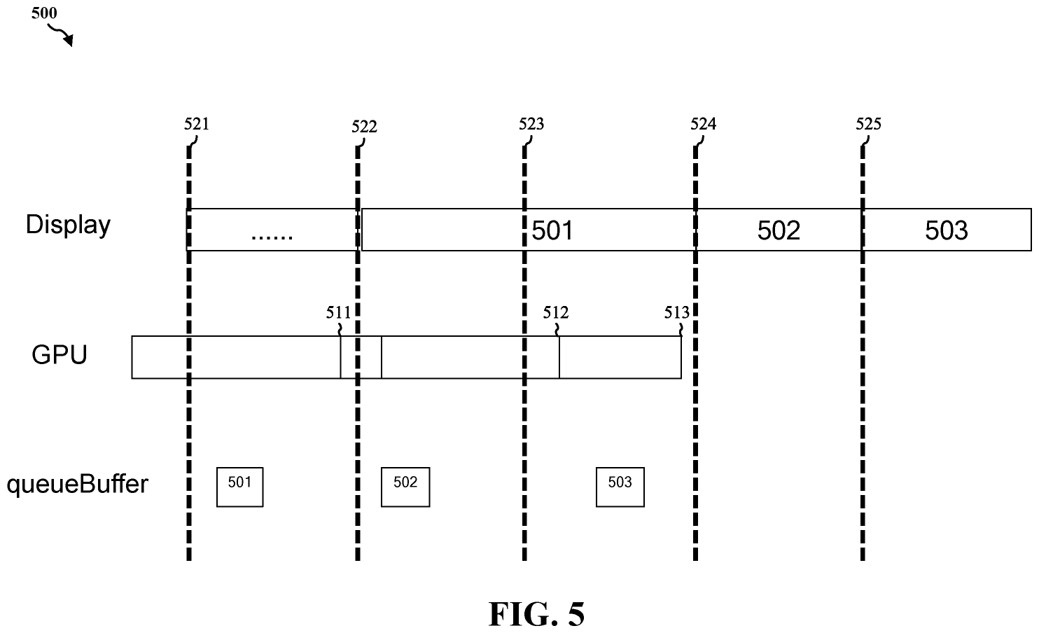

FIGS. 5-13 illustrate other example timing diagrams 500-1300, respectively, according to the present disclosure. More specifically, FIGS. 5-13 display nine examples of a frame composer running in game mode according to the present disclosure.

FIG. 5 illustrates an example timing diagram 500 according to the present disclosure. As shown in FIG. 5, timing diagram 500 includes first frame 501, second frame 502, third frame 503, first VSYNC time 521, second VSYNC time 522, third VSYNC time 523, fourth VSYNC time 524, and fifth VSYNC time 525. FIG. 5 also displays the frames stored in the buffer queue or queueBuffer, a GPU, and a display. Timing diagram 500 also includes signal time 511, signal time 512, and signal time 513. Signal times 511, 512, 513 indicate when the GPU signals to the display that the first frame 501, second frame 502, and third frame 503, respectively, are to be transmitted to the display.

Timing diagram 500 also includes a mAheadNum variable which indicates how many VSYNC cycles are between a buffer queue or queueBuffer function and the expected rendering completion time of a current frame. For example, mAheadNum variable indicates a value of 1 when frame 501 enters the queueBuffer. When frame 502 enters the queueBuffer, mAheadNum variable indicates a value of 1 as frame 501 was sent to the display before frame 502 entered the queueBuffer. However, as frame 502 was not yet sent to the display when frame 503 entered the queueBuffer, mAheadNum variable indicates a value of 2 when frame 503 is in the queueBuffer. FIG. 5 also displays that the frame composer in timing diagram 500 experiences a jank. For instance, signal time 512 occurs after the third VSYNC time 523, so the display does not show frame 502 until fourth VSYNC time 524. Accordingly, frame 501 is displayed from second VSYNC time 522 until fourth VSYNC time 524. This results in a user experiencing a jank.

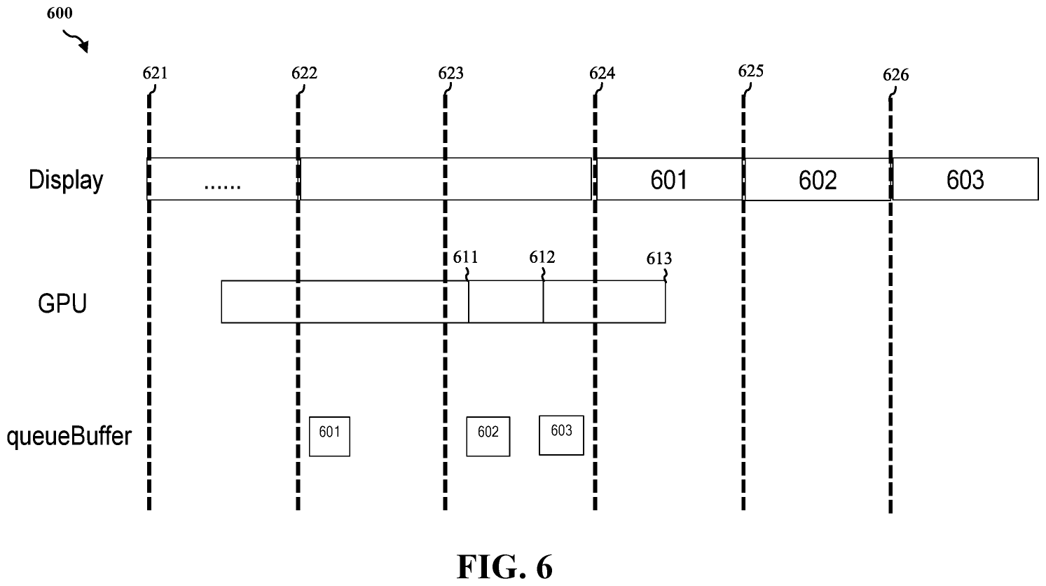

FIG. 6 illustrates another example timing diagram 600 according to the present disclosure. FIG. 6 shows that timing diagram 600 includes first frame 601, second frame 602, third frame 603, first VSYNC time 621, second VSYNC time 622, third VSYNC time 623, fourth VSYNC time 624, fifth VSYNC time 625, and sixth VSYNC time 626. FIG. 6 also displays the frames stored in the buffer queue or queueBuffer, a GPU, and a display. Timing diagram 600 also includes signal time 611, signal time 612, and signal time 613. Similar to the signal times in FIG. 5 above, signal times 611, 612, 613 indicate when the GPU signals to the display that the first frame 601, second frame 602, and third frame 603, respectively, are to be transmitted to the display.

Timing diagram 600 also includes a mAheadNum variable indicating how many VSYNC cycles are between a buffer queue or queueBuffer function and the expected rendering completion time of a current frame. For example, mAheadNum variable indicates a value of 1 when frame 601 enters the queueBuffer. When frame 602 enters the queueBuffer, mAheadNum variable indicates a value of 2 as frame 601 was not yet sent to the display before frame 602 entered the queueBuffer. Further, as frames 601 and 602 were both not yet sent to the display when frame 603 entered the queueBuffer, mAheadNum variable indicates a value of 3 when frame 603 enters the queueBuffer. FIG. 6 displays that the frame composer in timing diagram 600 does not experience a jank.

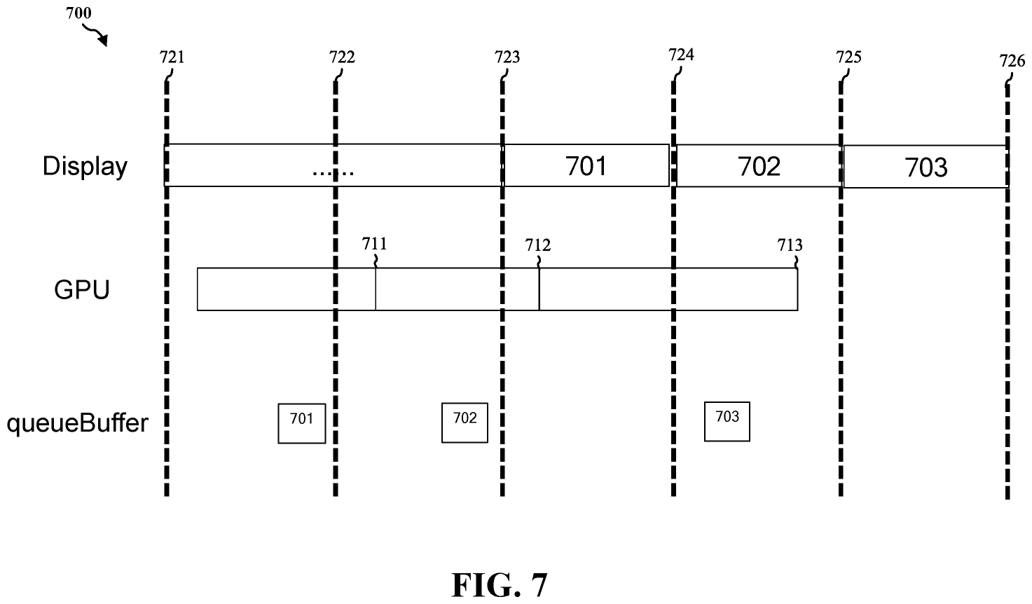

FIG. 7 illustrates another example timing diagram 700 according to the present disclosure. As shown in FIG. 7, timing diagram 700 includes first frame 701, second frame 702, third frame 703, first VSYNC time 721, second VSYNC time 722, third VSYNC time 723, fourth VSYNC time 724, fifth VSYNC time 725, and sixth VSYNC time 726. FIG. 7 also displays the frames stored in the buffer queue or queueBuffer, a GPU, and a display. Timing diagram 700 also includes signal time 711, signal time 712, and signal time 713. Similar to the signal times in FIGS. 5 and 6 above, signal times 711, 712, 713 indicate when the GPU signals to the display that the first frame 701, second frame 702, and third frame 703, respectively, are to be transmitted to the display.

Timing diagram 700 also includes mAheadNum variable. For example, mAheadNum variable indicates a value of 1 when frame 701 enters the queueBuffer. When frame 702 enters the queueBuffer, mAheadNum variable indicates a value of 2 as frame 701 was not yet sent to the display before frame 702 entered the queueBuffer. Also, mAheadNum variable indicates a value of 1 when frame 703 enters the queueBuffer, as frames 701 and 702 were both sent to the display when frame 703 entered the queueBuffer. FIG. 7 displays that the frame composer in timing diagram 700 does not experience a jank. Timing diagram 700 also indicates that the game mode is in a deteriorating status.

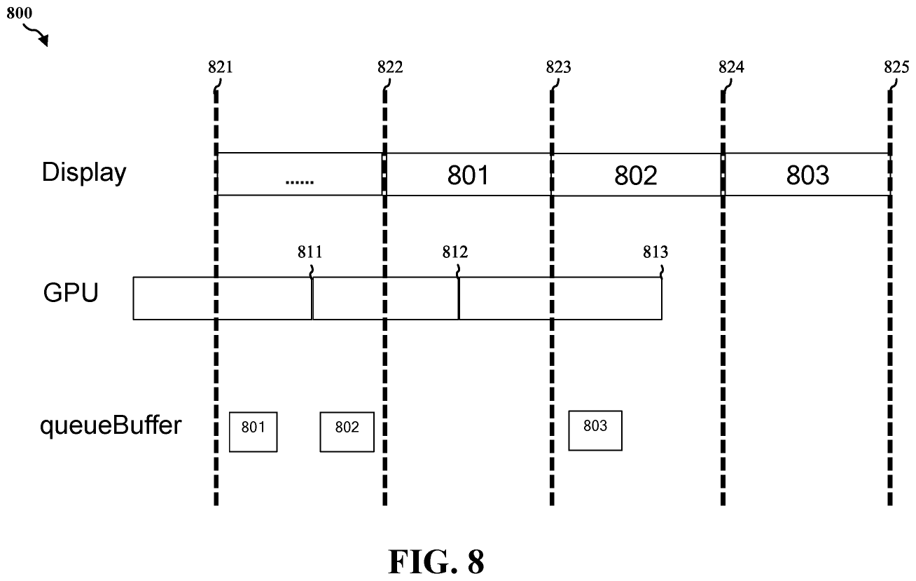

FIG. 8 illustrates another example timing diagram 800 according to the present disclosure. As shown in FIG. 8, timing diagram 800 includes first frame 801, second frame 802, third frame 803, first VSYNC time 821, second VSYNC time 822, third VSYNC time 823, fourth VSYNC time 824, and fifth VSYNC time 825. FIG. 8 also displays the frames stored in the buffer queue or queueBuffer, a GPU, and a display. Timing diagram 800 also includes signal time 811, signal time 812, and signal time 813. Similar to the signal times in FIGS. 5-7 above, signal times 811, 812, 813 indicate when the GPU signals to the display that the first frame 801, second frame 802, and third frame 803, respectively, are to be transmitted to the display.

Timing diagram 800 also includes mAheadNum variable. For example, mAheadNum variable indicates a value of 1 when frame 801 enters the queueBuffer. When frame 802 enters the queueBuffer, mAheadNum variable indicates a value of 2 as frame 801 was not yet sent to the display before frame 802 entered the queueBuffer. Moreover, mAheadNum variable indicates a value of 1 when frame 803 enters the queueBuffer, as frames 801 and 802 were both sent to the display when frame 803 entered the queueBuffer. Also, FIG. 8 displays that the frame composer in timing diagram 800 does not experience a jank. Like timing diagram 700 above, timing diagram 800 also indicates that the game mode is in a deteriorating status.

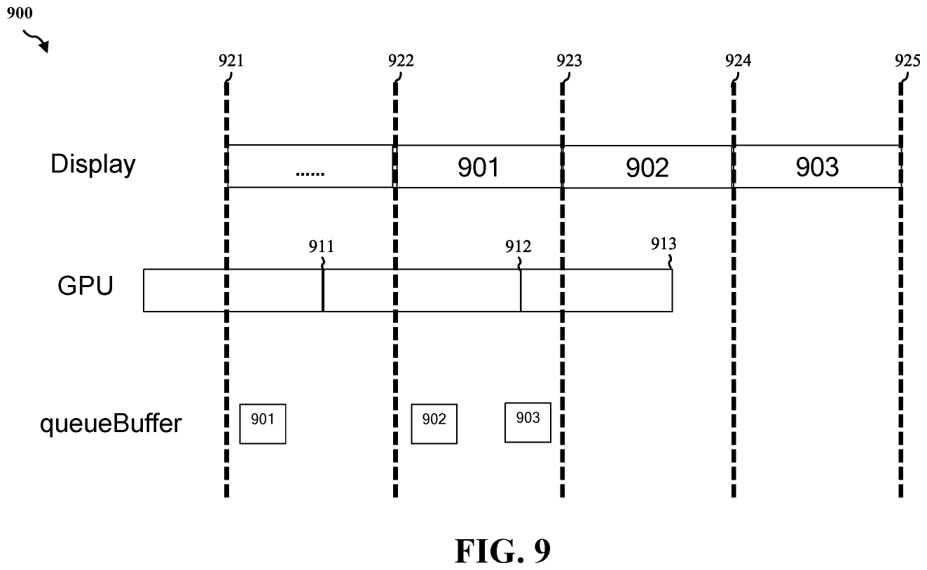

FIG. 9 illustrates another example timing diagram 900 according to the present disclosure. As shown in FIG. 9, timing diagram 900 includes first frame 901, second frame 902, third frame 903, first VSYNC time 921, second VSYNC time 922, third VSYNC time 923, fourth VSYNC time 924, and fifth VSYNC time 925. FIG. 9 also displays the frames stored in the buffer queue or queueBuffer, a GPU, and a display. Timing diagram 900 also includes signal time 911, signal time 912, and signal time 913. Similar to the signal times in FIGS. 5-8 above, signal times 911, 912, 913 indicate when the GPU signals to the display that the first frame 901, second frame 902, and third frame 903, respectively, are to be transmitted to the display.

Additionally, timing diagram 900 includes mAheadNum variable. For example, mAheadNum variable indicates a value of 1 when frame 901 enters the queueBuffer. When frame 902 enters the queueBuffer, mAheadNum variable also indicates a value of 1 as frame 901 was sent to the display before frame 902 entered the queueBuffer. Also, mAheadNum variable indicates a value of 2 when frame 903 enters the queueBuffer, as frame 902 was not yet sent to the display when frame 903 entered the queueBuffer. FIG. 9 also displays that the frame composer in timing diagram 900 does not experience a jank. Timing diagram 900 also indicates that the game mode is not in a deteriorating status.

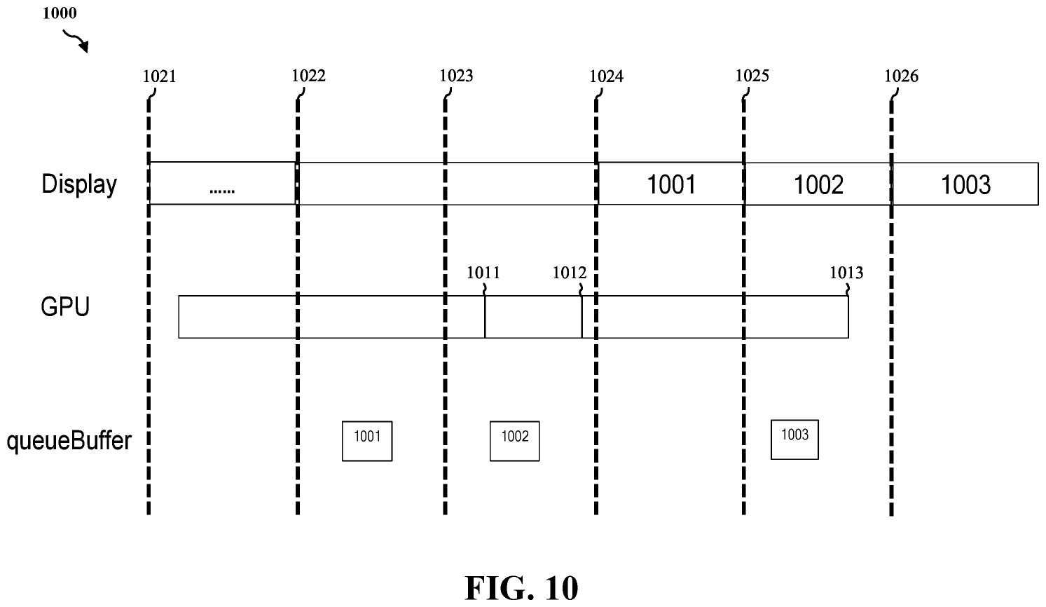

FIG. 10 illustrates another example timing diagram 1000 according to the present disclosure. As shown in FIG. 10, timing diagram 1000 includes first frame 1001, second frame 1002, third frame 1003, first VSYNC time 1021, second VSYNC time 1022, third VSYNC time 1023, fourth VSYNC time 1024, fifth VSYNC time 1025, and sixth VSYNC time 1026. FIG. 10 also displays the frames stored in the buffer queue or queueBuffer, a GPU, and a display. Timing diagram 1000 also includes signal time 1011, signal time 1012, and signal time 1013. Similar to the signal times in FIGS. 5-9 above, signal times 1011, 1012, 1013 indicate when the GPU signals to the display that the first frame 1001, second frame 1002, and third frame 1003, respectively, are to be transmitted to the display.

Timing diagram 1000 also includes mAheadNum variable. For example, mAheadNum variable indicates a value of 1 when frame 1001 enters the queueBuffer. When frame 1002 enters the queueBuffer, mAheadNum variable indicates a value of 2 as frame 1001 was not yet sent to the display before frame 1002 entered the queueBuffer. In addition, mAheadNum variable indicates a value of 1 when frame 1003 enters the queueBuffer, as frames 1001 and 1002 were both sent to the display when frame 1003 entered the queueBuffer. Also, FIG. 10 displays that the frame composer in timing diagram 1000 does not experience a jank. Like timing diagrams 700 and 800 above, timing diagram 1000 also indicates that the game mode is in a deteriorating status.

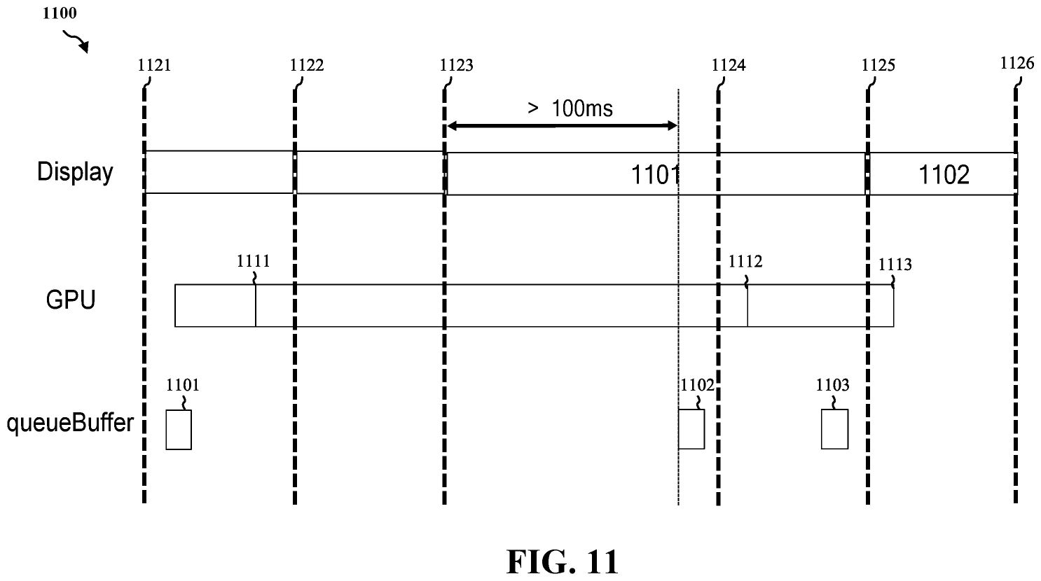

FIG. 11 illustrates another example timing diagram 1100 according to the present disclosure. As shown in FIG. 11, timing diagram 1100 includes first frame 1101, second frame 1102, third frame 1103, first VSYNC time 1121, second VSYNC time 1122, third VSYNC time 1123, fourth VSYNC time 1124, fifth VSYNC time 1125, and sixth VSYNC time 1126. FIG. 11 also displays the frames stored in the buffer queue or queueBuffer, a GPU, and a display. Timing diagram 1100 also includes signal time 1111, signal time 1112, and signal time 1113. Similar to the signal times in FIGS. 5-10 above, signal times 1111, 1112, 1113 indicate when the GPU signals to the display that the first frame 1101, second frame 1102, and third frame 1103, respectively, are to be transmitted to the display.

In addition, timing diagram 1100 includes mAheadNum variable. For example, mAheadNum variable indicates a value of 1 when frame 1101 enters the queueBuffer. When frame 1102 enters the queueBuffer, mAheadNum variable indicates a value of 1 as frame 1101 was sent to the display before frame 1102 entered the queueBuffer. In addition, mAheadNum variable indicates a value of 2 when frame 1103 enters the queueBuffer, as frame 1102 was not yet sent to the display when frame 1103 entered the queueBuffer. Timing diagram 1100 also indicates that the game mode is not in a deteriorating status. Moreover, timing diagram 1100 displays that the time period between third VSYNC time 1123 and when frame 1102 enters the queueBuffer is greater than 100 ms.

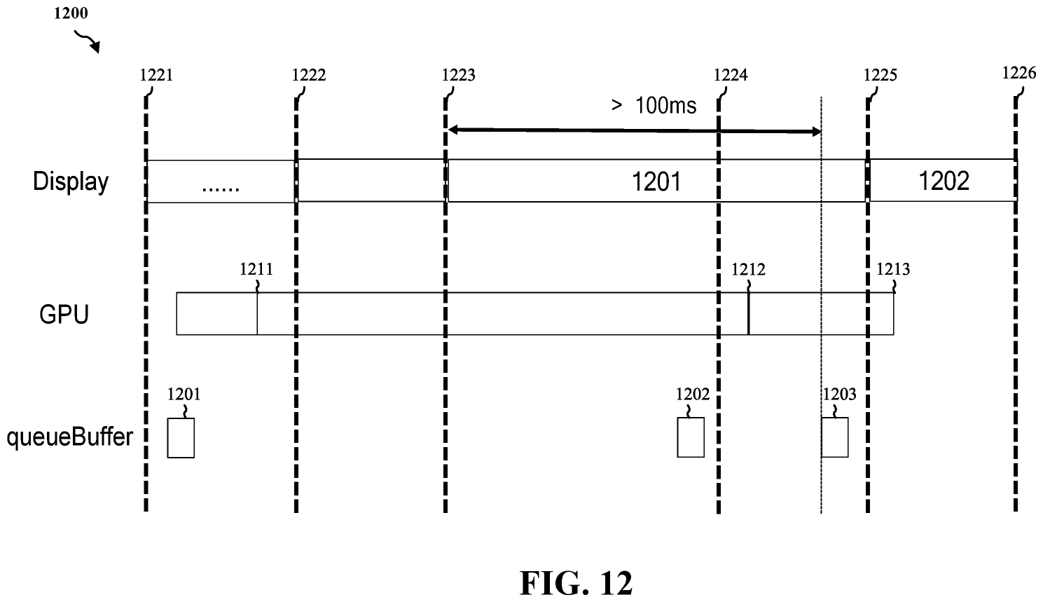

FIG. 12 illustrates another example timing diagram 1200 according to the present disclosure. As shown in FIG. 12, timing diagram 1200 includes first frame 1201, second frame 1202, third frame 1203, first VSYNC time 1221, second VSYNC time 1222, third VSYNC time 1223, fourth VSYNC time 1224, fifth VSYNC time 1225, and sixth VSYNC time 1226. FIG. 12 also displays the frames stored in the buffer queue or queueBuffer, a GPU, and a display. Timing diagram 1200 also includes signal time 1211, signal time 1212, and signal time 1213. Similar to the signal times in FIGS. 5-11 above, signal times 1211, 1212, 1213 indicate when the GPU signals to the display that the first frame 1201, second frame 1202, and third frame 1203, respectively, are to be transmitted to the display.

In addition, timing diagram 1200 includes mAheadNum variable. For example, mAheadNum variable indicates a value of 1 when frame 1201 enters the queueBuffer. When frame 1202 enters the queueBuffer, mAheadNum variable indicates a value of 1 as frame 1201 was sent to the display before frame 1202 entered the queueBuffer. In addition, mAheadNum variable indicates a value of 2 when frame 1203 enters the queueBuffer, as frame 1202 was not yet sent to the display when frame 1203 entered the queueBuffer. Timing diagram 1200 also indicates that the game mode is not in a deteriorating status. Further, timing diagram 1200 displays that the time period between third VSYNC time 1223 and when frame 1203 enters the queueBuffer is greater than 100 ms.

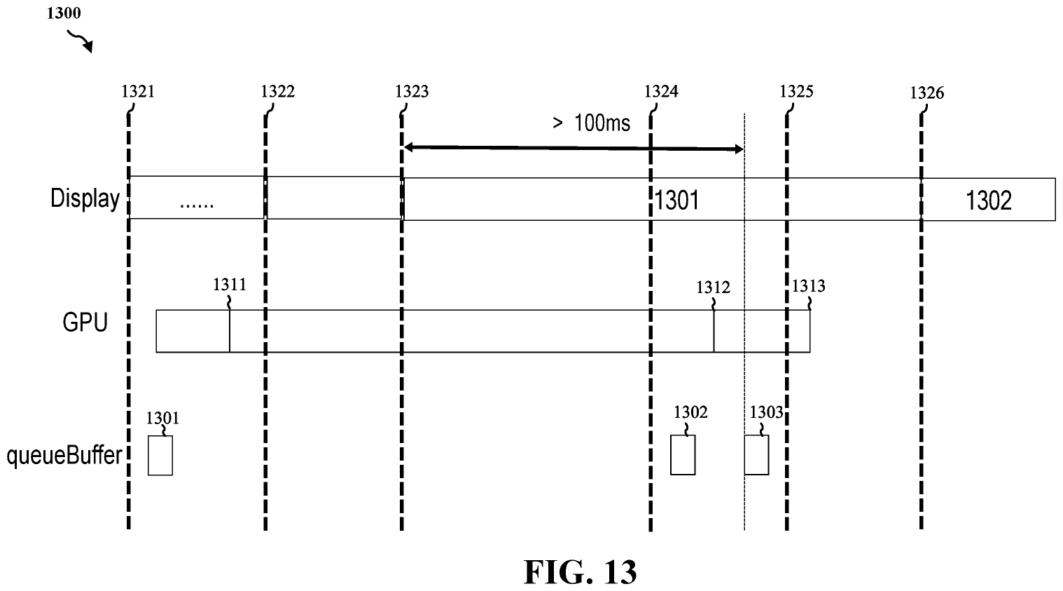

FIG. 13 illustrates another example timing diagram 1300 according to the present disclosure. As shown in FIG. 13, timing diagram 1300 includes first frame 1301, second frame 1302, third frame 1303, first VSYNC time 1321, second VSYNC time 1322, third VSYNC time 1323, fourth VSYNC time 1324, fifth VSYNC time 1325, and sixth VSYNC time 1326. FIG. 13 also displays the frames stored in the buffer queue or queueBuffer, a GPU, and a display. Timing diagram 1300 also includes signal time 1311, signal time 1312, and signal time 1313. Similar to the signal times in FIGS. 5-12 above, signal times 1311, 1312, 1313 indicate when the GPU signals to the display that the first frame 1301, second frame 1302, and third frame 1303, respectively, are to be transmitted to the display.

Also, timing diagram 1300 includes mAheadNum variable. For example, mAheadNum variable indicates a value of 1 when frame 1301 enters the queueBuffer. When frame 1302 enters the queueBuffer, mAheadNum variable indicates a value of 1 as frame 1301 was sent to the display before frame 1302 entered the queueBuffer. Further, mAheadNum variable indicates a value of 2 when frame 1303 enters the queueBuffer, as frame 1302 was not yet sent to the display when frame 1303 entered the queueBuffer. Timing diagram 1300 also indicates that the game mode is not in a deteriorating status. Also, timing diagram 1300 displays that the time period between third VSYNC time 1323 and when frame 1303 enters the queueBuffer is greater than 100 ms.

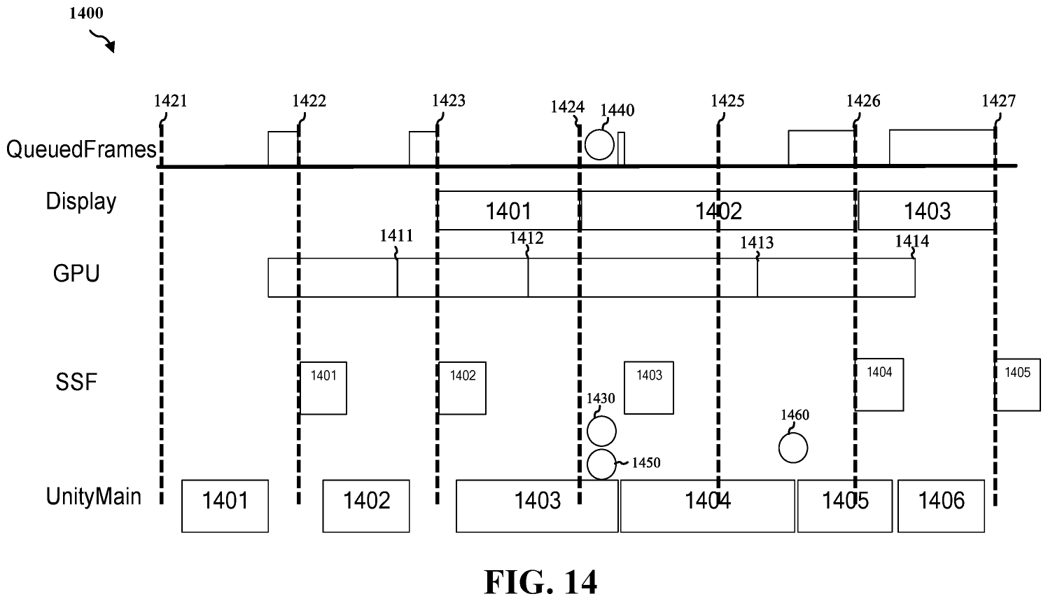

FIG. 14 illustrates another example timing diagram 1400 according to the present disclosure. As shown in FIG. 14, timing diagram 1400 includes first frame 1401, second frame 1402, third frame 1403, fourth frame 1404, fifth frame 1405, sixth frame 1406, first VSYNC time 1421, second VSYNC time 1422, third VSYNC time 1423, fourth VSYNC time 1424, fifth VSYNC time 1425, sixth VSYNC time 1426, and seventh VSYNC time 1427. FIG. 14 also displays a UnityMain or renderer, a SSF mechanism, a GPU, a display, and frames stored in the buffer queue (displayed as queuedframes). FIG. 14 displays a mobile gaming application that experiences a delayed frame rendering past a subsequent VSYNC time, e.g., third frame 1403 is rendered past fourth VSYNC time 1424, and experiences a corresponding jank. This also causes frames 1404 and 1405 to be rendered past VSYNC times 1425 and 1426, respectively.

FIG. 14 displays an example of a frame composer according to the present disclosure in the normal mode. For example, frame 1403 is rendered past fourth VSYNC time 1424, so the frame 1403 is consumed by the SSF mechanism immediately once the rendering is complete. The remaining frames, e.g., frames 1401, 1402, 1404, and 1405, are consumed as a subsequent VSYNC time, e.g., VSYNC time 1422, 1423, 1426, and 1427, respectively. Frame 1403 is consumed by SSF mechanism immediately upon finishing rendering, as frame 1403 completes rendering past the subsequent VSYNC time, e.g., VSYNC time 1424.

FIG. 14 also displays that timing diagram 1400 includes four points, e.g., point 1430, point 1440, point 1450, and point 1460. Point 1430 can be the point at which the queueBuffer function misses the VSYNC signal and is the expected time that frame 1403 should be sent to the buffer queue. For instance, as frame 1403 completes rendering after VSYNC time 1424, then frame 1403 is not sent to the buffer queue at point 1430. Rather, frame 1403 is briefly sent to the buffer queue once it completes rendering after point 1430. As shown in FIG. 14, frames 1401, 1402, 1403, 1404, 1405 are sent to the buffer queue at the VSYNC time after they are finished rendering. Also, at point 1430 the latency between VSYNC time 1424 and the point at which frame 1403 completes rendering can be less than a threshold. For example, the latency can be 4 ms. As the latency is less than a threshold, the SSF mechanism consumes the frame 1403 immediately upon rendering and sends frame 1403 to the buffer queue. Although the SSF mechanism consumes the frame 1403 immediately upon rendering, timing diagram 1400 still displays that the frame composer experiences a jank, which shows that the present disclosure can eliminate many, but perhaps not all potential janks. At point 1440, the value of mQueuedFrames can be set to a value of one, which means that there is only one available frame in the buffer queue. Point 1450 is the point at which SSF mechanism missed being triggered when the previous VSYNC signal was transmitted, e.g., at VSYNC time 1424, as frame 1403 had not yet completed rendering. Point 1460 displays that even if a jank occurs and the frame matches certain conditions, e.g., the conditions under points 1430, 1440, and 1450, the frame composer can still run in normal mode.

As mentioned above, game modes according to the present disclosure can include CPU hint and/or GPU hint strategies for frames that match certain conditions. For example, as shown in the examples in FIGS. 7, 8, and 10, certain cases within the game modes according to the present disclosure can have a deteriorating status. In some aspects, the CPU hint strategy can use a perfLock function to boost the CPU frequency for a time period, e.g., 50 ms. In other aspects, the GPU hint strategy can a GpuPerfHint function to increase the GPU frequency, such as by upgrading by one or more levels, e.g., 2 levels.

As mentioned above, frame composers according to the present disclosure can increase the FPS and/or decrease the janks experienced. For instance, some aspects of the present disclosure can increase the FPS experienced by the user when using gaming applications. For example, in a 60 FPS mode over a period of 1 minute the experienced FPS can be increased from 58.26 to 59.04. Moreover, some aspects of the present disclosure can reduce the janks experienced by the user when using gaming applications. For example, in a 60 FPS mode over a period of 1 minute the experienced janks can be reduced from 104 to 57. Accordingly, aspects of the present disclosure can reduce the janks experienced by users by around 45%.

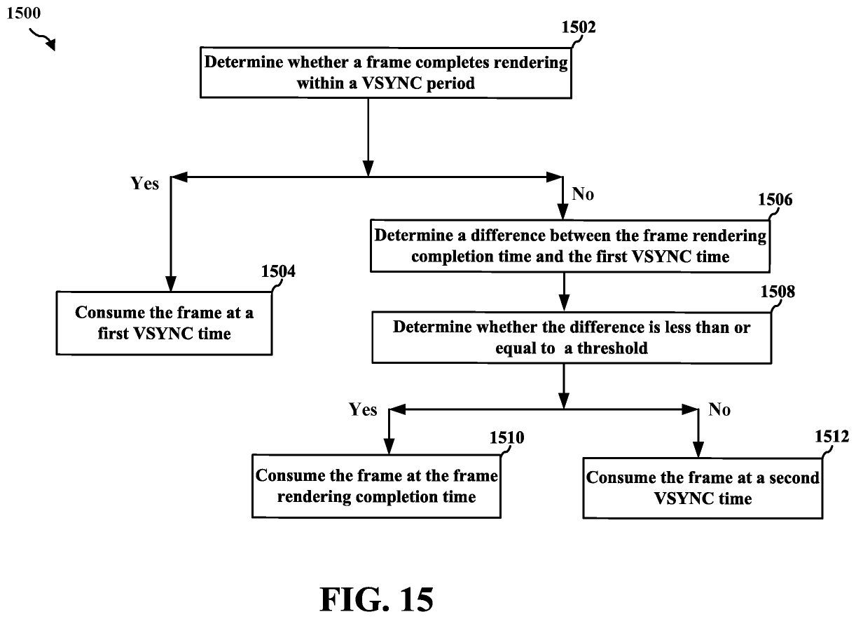

FIG. 15 illustrates an example flowchart 1500 of an example method in accordance with one or more techniques of this disclosure. The method may be performed by a frame composer, GPU, or apparatus for frame or graphics processing. At 1502, the apparatus may determine whether a frame completes rendering within a first VSYNC period, wherein the first VSYNC period begins at an initial VSYNC time and ends at a first VSYNC time, as described in connection with the examples in FIGS. 3-14. The frame can complete rendering at a frame rendering completion time. At 1504, the apparatus can consume the frame at the first VSYNC time if the frame rendering completion time is before or equal to the first VSYNC time, as described in connection with the examples in FIGS. 3-14. At 1506, the apparatus can determine a difference between the frame rendering completion time and the first VSYNC time if the frame rendering completion time is after the first VSYNC time, as described in connection with the examples in FIGS. 3-14. At 1508, the apparatus can determine whether the difference between the frame rendering completion time and the first VSYNC time is less than or equal to a threshold, as described in connection with the examples in FIGS. 3-14.

At 1510, the apparatus can consume the frame at the frame rendering completion time if the difference between the frame rendering completion time and the first VSYNC time is less than or equal to the threshold, as described in connection with the examples in FIGS. 3-14. At 1512, the apparatus can consume the frame at a second VSYNC time if the difference between the frame rendering completion time and the first VSYNC time is greater than the threshold, where the second VSYNC time is after the first VSYNC time, as described in connection with the examples in FIGS. 3-14.

Additionally, a SSF mechanism may consume the frame at the frame rendering completion time, as described in connection with the examples in FIGS. 3-14. In some aspects, the frame can be consumed at the frame rendering completion time if the frame rendering completion time is before or equal to the first VSYNC time, as described in connection with the examples in FIGS. 3-14. In other aspects, the frame can be consumed at the frame rendering completion time if the frame rendering completion time is before, equal to, or after the first VSYNC time, as described in connection with the examples in FIGS. 3-14.

In some aspects, the apparatus can send the frame to a buffer queue when the frame completes rendering, as described in connection with the examples in FIGS. 3-14. Moreover, the apparatus can increase a buffer queue counter of the buffer queue when the frame completes rendering, as described in connection with the examples in FIGS. 3-14. In addition, a processing speed of the frame composer can be based on the difference between the frame rendering completion time and the first VSYNC time, as described in connection with the examples in FIGS. 3-14. In some aspects, increasing the processing speed of the frame composer can increase a frame rendering time length or a frame consumption time length, as described in connection with the examples in FIGs.

In one configuration, a method or apparatus for operation of a frame composer is provided. The apparatus may be a frame composer, a GPU, or some other processor in frame or graphics processing. In one aspect, the apparatus may be the processing unit 120 within the device 104, the processing unit 106 within the device 102, or may be some other hardware within devices 102/104 or another device. The apparatus may include means for determining whether a frame completes rendering within a first VSYNC period. The first VSYNC period can begin at an initial VSYNC time and end at a first VSYNC time. Also, the frame can complete rendering at a frame rendering completion time. The apparatus can also include means for consuming the frame at the first VSYNC time if the frame rendering completion time is before or equal to the first VSYNC time. Further, the apparatus can include means for determining a difference between the frame rendering completion time and the first VSYNC time if the frame rendering completion time is after the first VSYNC time. The apparatus can also include means for determining whether the difference between the frame rendering completion time and the first VSYNC time is less than or equal to a threshold. Additionally, the apparatus can include means for consuming the frame at the frame rendering completion time if the difference between the frame rendering completion time and the first VSYNC time is less than or equal to the threshold. The apparatus can also include means for consuming the frame at a second VSYNC time if the difference between the frame rendering completion time and the first VSYNC time is greater than the threshold, where the second VSYNC time is after the first VSYNC time. In some aspects, the means for consuming the frame at the first VSYNC time can comprise means for sending the frame to a buffer queue at the first VSYNC time. Moreover, the apparatus can include means for increasing a buffer queue counter of the buffer queue if the frame rendering completion time is before or equal to the first VSYNC time.

The subject matter described herein can be implemented to realize one or more benefits or advantages. For instance, the described frame or graphics processing techniques can be used by frame composers, GPUs, or other frame or graphics processors to provide improved and dynamic janks reduction technology. The present disclosure can also improve or maintain the frame rendering or composition pipeline in order to help to reduce janks or delays in frame rendering or composition. In some aspects, the present disclosure can reduce janks without any corresponding reduction in power. In other aspects, the present disclosure can monitor a rendering status and/or a compositor status. In further aspects, the present disclosure can detect potentially harmful rendering or composition scenarios dynamically in advance.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method of operation of a frame composer, comprising:
determining whether a frame completes rendering within a first vertical synchronization (VSYNC) period, wherein the first VSYNC period begins at an initial VSYNC time and ends at a first VSYNC time, wherein the frame completes rendering at a frame rendering completion time;
consuming the frame at the first VSYNC time if the frame rendering completion time is before or equal to the first VSYNC time; and
determining a difference between the frame rendering completion time and the first VSYNC time if the frame rendering completion time is after the first VSYNC time.

2. The method of claim 1, further comprising:
determining whether the difference between the frame rendering completion time and the first VSYNC time is less than or equal to a threshold.

3. The method of claim 2, further comprising:
consuming the frame at the frame rendering completion time if the difference between the frame rendering completion time and the first VSYNC time is less than or equal to the threshold.

4. The method of claim 2, further comprising:
consuming the frame at a second VSYNC time if the difference between the frame rendering completion time and the first VSYNC time is greater than the threshold, wherein the second VSYNC time is after the first VSYNC time.

5. The method of claim 3, wherein a smart surface flinger (SSF) mechanism consumes the frame at the frame rendering completion time.

6. The method of claim 1, wherein the frame is consumed at the frame rendering completion time if the frame rendering completion time is before or equal to the first VSYNC time.

7. The method of claim 1, further comprising:
sending the frame to a buffer queue when the frame completes rendering.

8. The method of claim 7, further comprising:
increasing a buffer queue counter of the buffer queue when the frame completes rendering.

9. The method of claim 1, wherein a processing speed of the frame composer is based on the difference between the frame rendering completion time and the first VSYNC time.

10. The method of claim 9, wherein increasing the processing speed of the frame composer increases a frame rendering time length or a frame consumption time length.

11. An apparatus for operation of a frame composer, comprising:
a memory; and
at least one processor coupled to the memory and configured to:
determine whether a frame completes rendering within a first vertical synchronization (VSYNC) period, wherein the first VSYNC period begins at an initial VSYNC time and ends at a first VSYNC time, wherein the frame completes rendering at a frame rendering completion time;
consume the frame at the first VSYNC time if the frame rendering completion time is before or equal to the first VSYNC time; and
determine a difference between the frame rendering completion time and the first VSYNC time if the frame rendering completion time is after the first VSYNC time.

12. The apparatus of claim 11, wherein the at least one processor is further configured to:
determine whether the difference between the frame rendering completion time and the first VSYNC time is less than or equal to a threshold.

13. The apparatus of claim 12, wherein the at least one processor is further configured to:
consume the frame at the frame rendering completion time if the difference between the frame rendering completion time and the first VSYNC time is less than or equal to the threshold.

14. The apparatus of claim 12, wherein the at least one processor is further configured to:
consume the frame at a second VSYNC time if the difference between the frame rendering completion time and the first VSYNC time is greater than the threshold, wherein the second VSYNC time is after the first VSYNC time.

15. The apparatus of claim 13, wherein a smart surface flinger (SSF) mechanism consumes the frame at the frame rendering completion time.

16. The apparatus of claim 11, wherein the frame is consumed at the frame rendering completion time if the frame rendering completion time is before or equal to the first VSYNC time.

17. The apparatus of claim 11, wherein the at least one processor is further configured to:
send the frame to a buffer queue when the frame completes rendering.

18. The apparatus of claim 17, wherein the at least one processor is further configured to:
increase a buffer queue counter of the buffer queue when the frame completes rendering.

19. The apparatus of claim 11, wherein a processing speed of the frame composer is based on the difference between the frame rendering completion time and the first VSYNC time.

20. The apparatus of claim 19, wherein increasing the processing speed of the frame composer increases a frame rendering time length or a frame consumption time length.

21. An apparatus for operation of a frame composer, comprising:
means for determining whether a frame completes rendering within a first vertical synchronization (VSYNC) period, wherein the first VSYNC period begins at an initial VSYNC time and ends at a first VSYNC time, wherein the frame completes rendering at a frame rendering completion time;
means for consuming the frame at the first VSYNC time if the frame rendering completion time is before or equal to the first VSYNC time; and
means for determining a difference between the frame rendering completion time and the first VSYNC time if the frame rendering completion time is after the first VSYNC time.

22. The apparatus of claim 21, further comprising:
means for determining whether the difference between the frame rendering completion time and the first VSYNC time is less than or equal to a threshold.

23. The apparatus of claim 22, further comprising:
means for consuming the frame at the frame rendering completion time if the difference between the frame rendering completion time and the first VSYNC time is less than or equal to the threshold.

24. The apparatus of claim 22, further comprising:
means for consuming the frame at a second VSYNC time if the difference between the frame rendering completion time and the first VSYNC time is greater than the threshold, wherein the second VSYNC time is after the first VSYNC time.

25. The apparatus of claim 23, wherein a smart surface flinger (SSF) mechanism consumes the frame at the frame rendering completion time.

26. The apparatus of claim 21, wherein the frame is consumed at the frame rendering completion time if the frame rendering completion time is before or equal to the first VSYNC time.

27. The apparatus of claim 21, further comprising:
means for sending the frame to a buffer queue when the frame completes rendering.

28. The apparatus of claim 27, further comprising:
means for increasing a buffer queue counter of the buffer queue when the frame completes rendering.

29. The apparatus of claim 21, wherein a processing speed of the frame composer is based on the difference between the frame rendering completion time and the first VSYNC time.

30. A computer-readable medium storing computer executable code for operation of a frame composer, comprising code to:
determine whether a frame completes rendering within a first vertical synchronization (VSYNC) period, wherein the first VSYNC period begins at an initial VSYNC time and ends at a first VSYNC time, wherein the frame completes rendering at a frame rendering completion time;
consume the frame at the first VSYNC time if the frame rendering completion time is before or equal to the first VSYNC time; and
determine a difference between the frame rendering completion time and the first VSYNC time if the frame rendering completion time is after the first VSYNC time.
